(19) United States
(12) Patent Application Publication
(10) Pub. No.: US 2008/0136901 A1
(43) Pub. Date: Jun. 12, 2008

(54) Sweet Spot Unit

(75) Inventor: Alexander Schwerdtner, Dresden (DE)

Correspondence Address: SYNNESTVEDT LECHNER & WOODBRIDGE LLP, P O BOX 592, 112 NASSAU STREET, PRINCETON, NJ, 08542-0592, US

(73) Assignee: SeeReal Technologies S.A., Luxembourg (LU)

(21) Appl. No.: 11/813,533

(22) PCT Filed: Jan. 6, 2006
(86) PCT No.: PCT/DE06/00008

§ 371 Date: Jul. 9, 2007

(30) Foreign Application Priority Data
Jan. 7, 2005 (DE) 10 2005 001 503.4

(51) Int. Cl. H04N 13/04

(52) U.S. Cl. 348/51; 348/E13.075

(57) ABSTRACT

The invention relates to a sweet spot unit which focuses light at predeterminable regions in space in sweet spots by at least one flat controllable optical matrix and an optical mask. Sweet spots designate the zones of autostereoscopic viewing that are free of cross-talking. The unit comprises a controllable optical matrix (BM) with a multitude of controllable and regularly arranged pixels, and an optical mask (LM*), which is tolerance-loaded due to manufacture or other influences, with projection elements (L1*, L2*, . . . ), whereby along a section along any line pixels of this line are assigned to the projection elements (L1*, L2*, . . . ), said pixels being projected to any predetermined sweet spots by projection elements, characterized by that those pixels assigned to the projection elements are activated by program means that are congruently projected into the predetermined sweet spots.

The invention relates to a sweet spot unit which focuses light at predeterminable regions in space in sweet spots by at least one flat controllable optical matrix and an optical mask.

Sweet spots designate the zones of autostereoscopic viewing that are free of cross-talking.

Sweet spot units are advantageously used for projecting extended images or video sequences on to predetermined regions in space, from where they can be viewed with one or both eyes due to control of their size.

In autostereoscopic displays, the light of the sweet spot unit permeates large areas of the information panel which follows in direction of light propagation. The panel modulates the light alternately with the right and left image content. The light for the left sweet spots is modulated with the left images, the light for the right sweet spots is modulated with the right images, and focused on to the left or right eyes of the viewers, respectively.

Neither cross-talking to the other eye nor any disturbance of the homogeneity of the images on the information panel is permitted, when the panel is viewed from the sweet spot units.

The images or video sequences may be provided using a transmissive form such as a permeated panel or also a reflective form. Directed backlights are an important field of application, where persons are provided with different information, such as the driver of a car who is provided with information on the route, while the passenger is viewing a film. Backlights in autostereoscopic displays can time-sequentially project left and right image contents to the left and right eyes of viewers.

The optical masks are intended to project the pixel configurations of the large-area controllable optical matrices to form sweet spots.

The masks contain arrays of projection elements, such as of micro lenses, or are established stripe-shaped as lenticular-arrays. They can also be established as holographic optical elements (HOE), switchable elements such as lenses with variation of the focal length or optical axes, or as combinations of the individual optical elements among or with each other.

Advantageously, the projection elements are aligned adjacent as close as possible. This suppresses transitions when projecting the extended light source, and after modulation with information from the sweet spots, enables viewing a stereoscopic representation.

The optical matrix is the controlling element that adjusts region, number and extent of the sweet spots, said matrix advantageously comprising a multitude of regular, individually controllable pixel elements, which usually are arranged matrix- or line-like.

A controllable optical matrix is defined here as generic term for a self luminous trans-missive or transflexive light modulator matrix, the elements of which, being individually controllable, influence the intensity, and, as a rule, are monochrome. For colour representations of the images, the information-carrying mediums such as the panel are either equipped with colour filters, or they are modulated monochromatically with primary colours from the optical matrix in a sequential manner. A controllable optical matrix, as a rule, constitutes the active part of the sweet spot unit for controlling the number, position and size of arbitrarily given sweet spots.

TFTs, CRTs, LEDs, OLEDs, but also micro-mirror devices, phase modulators and other devices are suitable controllable optical matrices. Such components are often designed as regular pixel arrangements. In colour displays, said arrangements are composed of colour subpixels in most cases. Sometimes monochrome displays also use pixels that are divided into subpixels. In the following, a pixel is understood to be the smallest controllable and mostly monochrome unit, also including the subpixel.

In the simplest case, the controllable optical matrix can contain individual light sources, and the optical mask can be single lens. Such arrangements, however, show considerable optical errors, which in autostereoscopic systems lead to cross-talking on to the wrong eyes of the viewers. Further, they are very voluminous and due to the required focal length of the single lens they have a considerable depth, which contradicts a desired flatness of displays.

Parallel optical systems used as controllable optical matrix and optical mask reduce the optical errors, structural depth and the weight of the displays, simplify the control, and enable optical errors to be corrected, so that cross-talking is avoided and the images and image sequences views are homogenized.

Usually the optical masks are established as lenticular-arrays and, typically, have a very small pitch. For sweet spot units, the pitch and position of the projection elements in relation to the controllable optical matrix are exactly defined, being a multiple of the pixel pitch of a controllable optical matrix. The lenticular-array pitch and the pixel position in relation to the optical mask are also assigned fixed and adjusted to each other.

With regard to an exact projection a precise assignment of pixels of the controllable optical matrix to each projection element is required.

Hence, very high demands on the assignment and adjustment of the controllable optical matrix and the optical mask are set. Since the technology of manufacturing matrices is well established, deviations can be neglected. Within this document, controllable optical matrices are considered to be ideal and accurate.

Deviations in shape and structure of optical masks are caused, above all, by the manufacturing technology, as the masks typically are made by replication methods. Hereby, for example, glass substrates coated with a thin polymer, which is then embossed to form a lenticular-array and cured by UV-light. Also the whole lenticular-array can be made of polymer itself.

Films that contain the lenticular-array in embossed form are particularly problematic, but especially such an embodiment is tempting due to its cost-effective manufacture.

While the technology of manufacturing optical matrices, e.g. as an arrangement of luminous pixels, is well developed delivering almost ideal pixel positions, optical masks, apart from the known optical errors, above all show deviations in the positions and pitches of the projection elements which cause errors when forming the sweet spots.

In order to achieve a high-quality optical projection, it is necessary that the projection elements, the lenticules of a lenticular-array in the example, are precisely assigned to the pixels of the controllable optical matrix.

In all known solutions, as a rule, it is necessary that the lenticular, compared to the pixel pitch of the controllable optical matrix, has a homogeneous pitch and a defined position in relation to all lenticules. These requirements on the tolerances of each optical mask can only be fulfilled at high manufacturing effort. In addition to the form deviations of the lenticules, which are not subject of this invention, particularly the position deviations of the lenticules adversely affect the quality of the optical image. They make the individual lenticules to project their sweet spot portions only inexactly in space. The viewer disadvantageously discerns cross-talking and inhomogeneities when viewing the stereo images.

Distortions or offset of the lenticular-array can be compensated by appropriate adjustment, but only for the optical mask as a whole. However, such an adjustment is not possible for pitch deviations within the optical mask. Particularly susceptible to errors concerning the assignment of the optical matrix and the optical mask is the use of lenticular-films, which can hardly be positioned accurately.

The problems of the assignment of a matrix-shaped image to a lens raster are known for long from the field of lens raster images (lenticular prints). These problems do not apply to the sweet spot unit; they include, however, elements of the assignment of image points to a lenticular-array. Here the basic object is not to generate sweet spots from large-area light sources, but the image separation. Typically, fan-like projections of several images are concerned, which are systematically arranged below each lenticule. In manufacture, an adjustment process is required, which aligns the lens raster such that it exactly matches the print image. This process, often carried out manually, is simplified and automated using auxiliary rasters, line images, test image stripes or the like. Nevertheless, the process continues to be cost-effective.

DE 1 597 168 exemplarily discloses a method for facilitating the manual alignment and adjustment by means of test image stripes.

EP 0 570 807 B1 describes a method and device for adjustment of a lens raster arrangement with a separate image sheet, a video camera and moiré methods being employed.

EP 0 801 324 B1 describes a device, where the amplification and adjustment of an integral, composed image to a lens substrate is controlled by means of reference patterns, which contain the necessary measuring data in order to change the size, rotation and position of the image such that the image can be adapted to a regular lens arrangement.

WO9924862A1 describes a method and device for automated manufacture of a stereoscopic lens raster image, without highly-accurate arrangements of lens raster elements being necessary so that it is ensured that the accuracy of the printed image is adapted to the geometry of the lens screen.

According to one aspect of the document, a means for manufacturing a lens raster image is provided that includes a system for detecting the position of at least one reference line which is in connection with a line and/or an edge of an image-carrying substrate so that when the method is used an element of the image is positioned on the substrate relative to the at least one line and/or edge.

The document describes a further method where a light permeated auxiliary raster is used, which is disposed in the focal plane of the lens screen. The lens screen delivers moiré patterns, which are caught, e.g., by a charge coupled device (CCD detector) and EDP means. An error-map is calculated with help of these digital patterns, according to the inhomogeneous arrangement of the lens elements in relation to the reference arrangement of the lens raster, whereby for the content of the image a corresponding shift is provided at each individual point in order to compensate for the deviation of the lens elements from the regular reference arrangement.

GB 2 352 514 describes a method for controlling the position of a lens screen (array) in relation to an LCD in order to provide an autostereoscopic image. Here the array is scanned using a directed light ray, whereby an observed phase shift serves to determine the axis deviation of the lenticular-array in the course of the printing process so that a more precise rotational adjustment of the array relative to the image is made possible.

Tracked autostereoscopic displays do not correct the pitch deviations present within the lenticular, but the lenticular-arrays as a whole follow the viewer position. These methods therefore do not apply to this invention. Those non-mechanical methods are an exception, where manipulations of the pixel assignments to the lenticular-arrays are used.

The latter method of viewer tracking in autostereoscopic displays is exemplarily described in WO 9827451, whereby barrier-, lens raster-, or prism mask methods are used on flat displays.

When the viewer moves laterally in front of the display the intensities of the horizontal R-, G- or B-subpixels are directly or indirectly assigned to neighbouring pixels, according to the viewer position (e.g. by way of head tracking). In this way, proportional to the lateral movement, the image contents are shifted colour point per colour point, i.e. subpixel per subpixel, without the display itself, or a barrier grid or cylindrical lenses being moved, or a lateral movement being carried out by other optical means.

This method is also extended to include more than three subpixels per pixel. In an embodiment with a usual display, where on a line three colour subpixels for the colours red, green and blue periodically follow each other, four colour subpixels are controlled for each image point.

EP 0 691 000 B1 describes an autostereoscopic multi-user display that is based on a sweet spot unit. Seen in direction of light propagation, it comprises an illumination matrix, followed by a projection matrix. The illumination matrix can be operated in transmission mode together with a usual backlight, or actively in emission mode. The openings, which are arranged matrix-like, of the illumination matrix are projected by a projection matrix to sweet spots at predetermined regions, i.e. the right or left eyes of viewers, these positions being detected by a position finder. A number of openings are exactly assigned to each projection element of the projection matrix, which may be a lenticular-array, at the positions of the projection element in space. Openings and projection elements therefore must accurately be adjusted to each other.

The light of the large-area projection matrix on its path to the sweet spots permeates the information panel, which time-sequentially modulates the light with the left or right image.

Great requirements on the illumination and projection matrices are thus established. These two elements are relevant for the image quality discerned by the viewer, particularly for cross-talking and image homogeneity. Not only a high level of trueness of shape, but above all the exact assignment of the illumination and projection matrices is critical, that is the exact positioning of the pixels of the illumination matrix relative to the projection elements, in this example the lenticules.

Particularly for a large-area sweet spot unit, the object of the invention is to establish a large-area light source, in order to focus sweet spots using available or technologically and economically realizable means on to any predetermined regions in a certain region of space, of high quality. For the purposes of this invention, high quality is defined as the fact that the large-area light source is focused into spatially predetermined, limited sweet spots, from where the large-area light source appears to be homogeneous. Particularly, cross-talking of sweet spots, which are sequentially determined for the right or left eyes of the viewers, to the respective other eye of the viewers is not to occur.

Influences that originate from the projection quality of the optical matrix, such as optical errors, or from the quality of the optical matrix, such as the arrangement or structuring of the pixels, are not included.

For autostereoscopic displays, between the sweet spot unit and the viewer a trans-missive information panel is disposed, which modulates the light and through positioning of the sweet spots on to right or left viewer eyes, presents the right or left image contents sequentially and synchronously.

Instead of the transmissive display, also a reflective display may be used. Use of the sweet spot unit is, further, not limited to autostereoscopic displays, but can present different information to different viewers, such as to two pilots of an aircraft.

The main object of the invention is to provide economically favourable tolerance-loaded optical masks and the effective assignment of such masks to the controllable optical matrices. Particularly, for optical masks with pitch and position deviations, above all film-based lenticular-arrays, and for the use of maladjusted optical masks and controllable optical matrices solutions for practical applications are disclosed.

In order to achieve this goal, it is the first object of the invention to ensure that the pixels of the controllable optical matrix are adjusted to the geometry of the used optical mask, in the sense of the defined high quality, although the concrete raster structure of the optical mask deviates from the regular ideal structure.

Above all for economic reasons it is intended to reduce the demanding requirements on the structural accuracy of the optical masks, without substantially reducing the high quality as defined of the sweet spot unit. That means that an optical mask is assumed having deviations in pitch and position of the projection elements, as it may be, for example, with film-based or other lenticular-arrays but also when the lateral adjustment is poor.

Adjustment in terms of displacement and/or rotation of the whole optical mask relative to the controllable optical matrix can only lead to improvement in the sense of optimization, but not to the defined high quality of the sweet spot unit. Position deviations that, for example, vary over the display cannot be compensated in this way. This method of correction is not usable if the optical mask and the controllable optical matrix are bonded, or fixed to each other in any other way.

As a summary, it is intended to enable manufacturing a sweet spot unit featuring the high quality as defined at low cost and with high process reliability.

This object is solved by the characterizing features of the main claim. Advantageous embodiments of the invention follow from the subsequent claims.

The sweet spot unit, particularly for autostereoscopic displays, contains at least one controllable optical matrix with a multitude of regularly arranged transmissive or self luminous pixels. The pixels, with subpixels also subsumed under pixels, are typically monochrome and arranged in form of a matrix.

Further, the sweet spot unit contains a finely structured optical mask which has a multitude of adjacent projection elements which usually are established stripe-like in vertical direction, as lenticules of a lenticular-array. The projection elements can also be regularly arranged in form of a matrix or in any other form. The geometry of the projection elements defines a raster structure, defined for example, by the contour, or the vertices or vertex lines of the projection elements.

For the sweet spot unit, p controllable pixels are assigned to each projection element along a horizontal section on a line, said pixels generating sweet spots in the viewer plane. For stripe-shaped projection elements, particularly lenticular-arrays with vertical lenticules, the sweet spots form stripes at predetermined regions preferably with a width that corresponds to the eye distance of a viewer.

Using matrix-shaped projection elements, such as micro lens arrays, or for two crosswise arranged lenticular-arrays, sweet spots in both horizontal and vertical directions are generated

Compared to the high accuracy of position and pitch of the controllable optical matrix, the geometry of the raster structure of the optical mask typically exhibits deviations. This may be caused by inaccurate positioning and pitch of the projection elements, or the relative positions of both components to each other. These errors of position are a result of displacement or rotation.

In the following, reference is made to a line-per-line, i.e. horizontal adjustment of the pixels of the controllable optical matrix to the projection elements of the optical mask, and to horizontal viewer tracking, as well. Sweet spots generated in both horizontal and vertical directions can be considered similarly.

Previous to the line-per-line assignment of the pixels, or subpixels to the optical mask, position and pitch of the tolerance-loaded projection elements are measured. For that the sweet spot unit is provided with means for storing the irregular raster structure of the optical mask. For example, the positions of the projection elements are stored for a multitude of pixel lines.

According to the sweet spot position to be set, the pixels of the controllable optical matrix are chosen line-per-line for the respective projection elements of the optical mask. Then the associated pixels, or subpixels, and their number and intensities are determined from the sweet spot positions to be set by a position finder.

The invention is based on the idea that pixels of the controllable optical matrix are assigned line-per-line to the irregular projection elements such that at the position of the line, the pixel position relative to the projection element corresponds to the position of the sweet spot.

The pixels controlled in shifted manner ensure by compensating for the irregular structure that the optical projection is not distorted; thus featuring the high quality as defined.

Hereby, in case lenticular-arrays are used, it is sufficient to maintain the position of the pixels relative to the central line, or the vertex of the lens considered. Often it is sufficient to choose a lens edge as reference. For other projection elements such as holographic ones a symmetry line will be chosen as reference.

A position finder, which determines the eye positions of the viewers for tracking, delivers the positions of the sweet spots. One position finder is sufficient, as a rule. In order to obtain directed illumination or generate extended sweet spots, i.e. zones of autostereoscopic viewing free of cross-talking, it is necessary for tracked autostereoscopic displays to create a projection directed in direction of one or several viewer(s). In the process of viewer tracking, for broader lateral movements of the viewer, the pixels on the lines are laterally shifted by one or several pixel widths. The value of the lateral shift for generating the sweet spots is approximately proportional to the lateral position change of the viewer. Whereas the pixels are bound to their positions on the display, the activated pixels for generating the sweet spots will shift along the display line corresponding to the lateral movement of the viewer.

In contrast to that, the known methods use fixed assignments of pixels of the optical matrix to the projection elements of the optical mask. Because in the technological process these idealizing assignments—ideal optical mask and error-free axis alignment—are normally violated, appropriate errors arise within the sweet spots. For example, proportions of the sweet spots, which originate from different projection elements, will no longer be congruent. The viewer sees the corresponding zones of the optical mask or the information panel in a dimmed condition.

Where pixels organized in colour subpixels, the controlled assignment is achieved first by choosing the associated combined pixel and then by the subpixel according to the colour position. Regarding RGB-organized monochrome pixels, the central sub-pixel is addressed by, for example, the colour green. To achieve larger sweet spots, accordingly more subpixels, or pixels, will be controlled and switched.

In order to ensure homogeneity of the viewed information panel, the transmissivity or intensity of the subpixels and pixels can take varying values. For controlling the total intensity all values of the subpixels or pixels can be uniformly increased or decreased.

Subpixels or pixels in binary mode, i.e. controlled by on/off-switching, are a special case. Such optical matrices that are controllable in binary mode, such as ferroelectric liquid crystal displays, are often characterized by a very short switching time compared to those with continuous values of intensity. If adjustment of the intensity of the subpixels is still desired, the intensity values of the subpixels are preferably approximated by a sequential trigger in binary on/off-mode.

Another idea of the invention relates to those pixels that are situated in the border region of the assignment to neighbouring projection elements. Particularly, this is the case when due to the viewer position, the irregular structure and/or a deviation of the axis, the assignment of certain pixel elements to a single projection element is not unique or not sufficiently precise.

According to the invention, the intensities of the pixels are overlapped in the border region of the assignment of the pixels to neighbouring projection elements. Preferably, the intensities of the pixels are overlapped according to the proportion of the assigned areas, the assignment to the projection elements and the sweet spots being performed on the basis of an idealized overlap. The pixels-values can also be weighted according to the intensity in order to suppress projection errors within the sweet spots.

Advantageously, the compensation according to the invention is performed, first, for inhomogeneous shifts of the projection elements against an ideal raster; second, for the case that the optical mask and the controllable optical matrix are fixed to each other, such as by bonding, in those cases, where axis-true adjustment of the optical mask relative to the controllable optical matrix was not successful. This case particularly arises if the optical mask is fixed to the controllable optical matrix directly or through an auxiliary structure, allowing only restricted corrections of position and axis. Generally, weighting of the pixel intensities for improving the defined high quality of the projection into the sweet spots is provided.

The images or video sequences can be provided in transmissive form, such as a transmitted panel, or also in reflective form. An important field of application is directed backlights, where persons can view different information, such as the driver of a passenger car who receives information on the route faded in, while the passenger sees a film. Backlights in autostereoscopic displays can provide sequentially left and right images to the corresponding eyes of viewers.

In both the manufacture of the optical masks, particularly using lenticular-films, and the alignment of the optical mask, the sweet spot unit allows efficient manufacture based on reliable processes by the assignment of pixels, or subpixels, according to the invention, here explained for line mode, to the projection elements according to the sweet spot positions and sizes to be adjusted.

It is seen that without restricting the high quality of the optical image, cost-effective assembly based on reliable processes of the total optical system can be achieved.

Further aspects and details of the invention are explained with help of the following examples of embodiment, particularly for autostereoscopic displays, and of the accompanying figures.

It is shown by

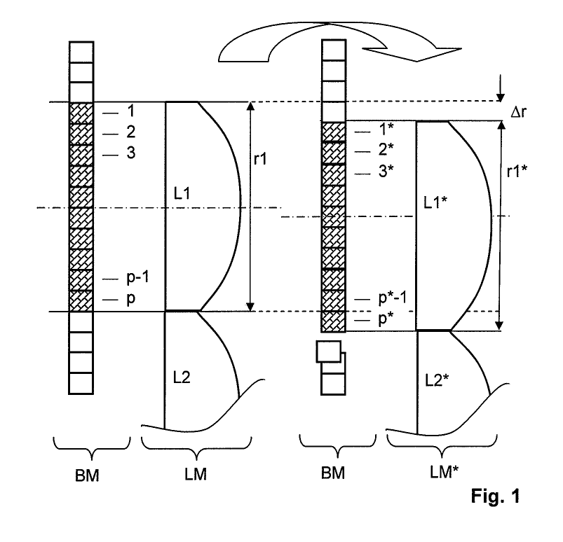

FIG. 1, a sweet spot unit according to the invention with an optical mask and a controllable optical matrix;

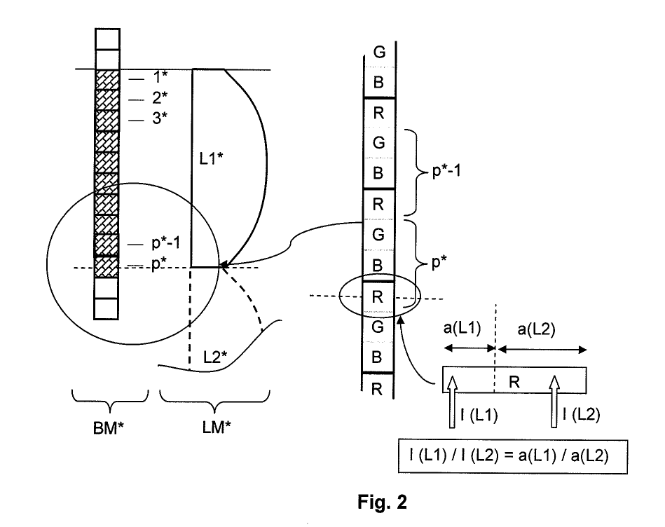

FIG. 2, a sweet spot unit according to the invention with an optical mask and a controllable optical matrix with detailed subpixels;

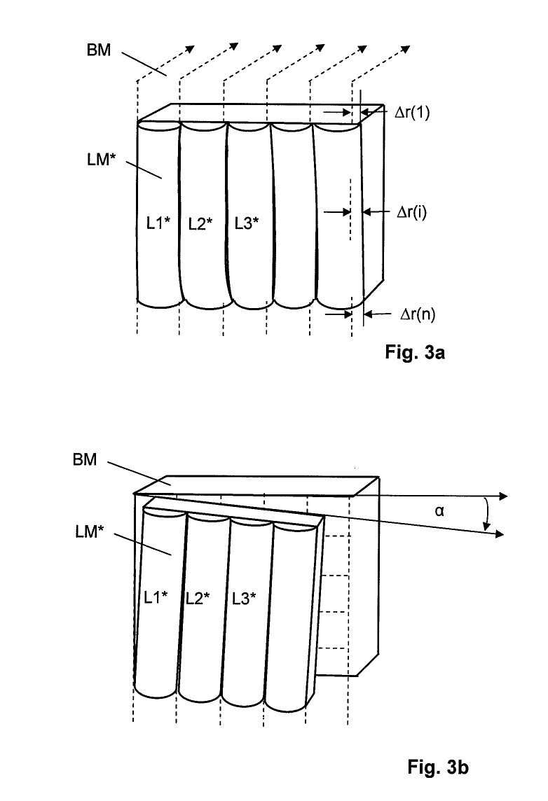

FIG. 3a, an optical mask with inhomogeneous projection elements;

FIG. 3b, an optical mask with a rotational axis deviation relative to a controllable optical matrix;

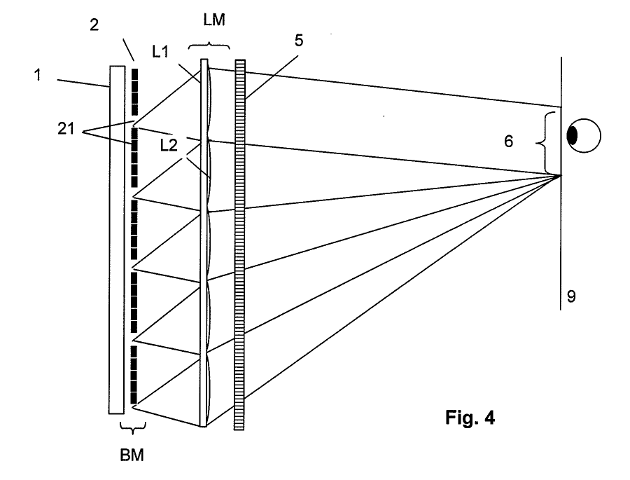

FIG. 4, a sweet spot unit according to the invention within an autostereoscopic display.

FIG. 1 shows a split schematic representation in top view. The figure shows a sweet spot unit with an optical mask and a controllable optical matrix.

The left section of the drawing shows a controllable optical matrix (BM) and an optical mask (LM), arranged subsequent in direction of light propagation. The controllable optical matrix (BM) contains a multitude of pixels or subpixels, respectively, which are assigned to the exactly positioned projection element (L1) in ideal manner.

Here the optical mask (LM) is a lenticular-array and comprises a multitude of adjacent lenticules (L1, L2, . . . ,) in form of cylindrical lenses, which are arranged vertical. Seen in direction of section along a pixel line, p pixels are assigned to a lenticule (L1), the pixels marked 1 . . . p in the representation.

The optical system, shown in the left portion, is characterized by a homogeneous optical mask. Said mask has a regular raster structure, whereby the geometry of the lenticular-arrays, particularly the pitch or pitch lines of them, is completely homogeneous and accurate in shape. Further, the adjustment of the optical mask relative to the pixel raster of the controllable optical matrix is axis-conforming.

The right part of the representation illustrates the similar optical system, that is a controllable optical matrix (BM) and lenticular-array, where however the optical mask (LM*) deviates from the regular position at this section along a pixel line.

It is seen from the representation that the a priori determined assignment of the pixels 1 . . . p relative to the irregular lenticule (L1*) is no longer congruent.

In the simplest case, the relative position can be sufficiently described by, or derived from the border lines of neighbouring lenticular-arrays or possibly, from the respective vertices of the lenticules.

According to the sweet spot position to be adjusted in each case and to the lateral shift of the accompanying pixels in conformity with said position, and compensating for the irregular position of the lenticule (L1*), the pixels of the controllable optical matrix are chosen and their number and intensity values controlled line per line. The activated pixels controlled in this way create the direction, region and number of the original sweet spots.

Compensating for the irregular position of the lenticule (L1*), those pixels 1 . . . p* are assigned to this lenticule controlled such that the position of said pixels relative to the irregular lenticule (L1*) approximates the position of the pixels 1 . . . p relative to the regular lenticule (L1).

It is seen in this figure that in this embodiment the range of the p pixels exactly covers the pitch of the accompanying lenticule. In this example of embodiment, the active pixels for generating the sweet spots remain within the pitch of the lenticule. It is conceivable that this range is larger, and even reaches in the pitch of neighbouring lenticules.

The drawing illustrates the basic shift correction in relation to one projection element. With the occurrence of a first irregular projection element, the corresponding error propagation provides the necessary shift correction of the subsequently adjacent projection elements.

The above mentioned example of embodiment illustrates the basic correcting shift of the pixels in pixel-by-pixel mode. A two-axis shift of the pixels with horizontal and vertical recoding will be achieved as superposition of the individual axis corrections in a largely similar way.

With an arrangement of the inexactly positioned optical mask (LM*) similar to that of FIG. 1, FIG. 2 shows the assignment of the pixels 1* . . . p* to the lenticule (L1*). P pixels are assigned to the lenticule (L1*), whereby the pixel elements similar to an image matrix are divided into further monochrome subpixels, such as colour subpixels R, G, B. The refinement of the assignment of the pixel elements and subpixels to the lenticule (L1*), or (L2*), is shown by a zoomed detailed view on the right.

Similar to FIG. 1, the range of the pixels 1* . . . p* that is assigned to the lenticule (L1*) exactly corresponds to the pitch of the lenticule. As can be seen from the representation, no unique assignment of a subpixel R is possible so that this subpixel has to be assigned to both lenticules (L1*) and (L2*).

In a first embodiment, this subpixel is assigned in both directions to the first lenticule (L1*) and the second lenticule (L2*). As seen in a further detailed representation, the intensities I(L1) and I(L2) of the subpixel are overlapped to (L1*) and (L2*) proportionately, according to the assignable ratio of the areas a(L1) and a(L2) of the subpixel. For a simpler solution, a homogeneously halving overlap of the intensities is conceivable.

In a schematic representation, FIG. 3a shows an irregular optical mask, which is established here as lenticular-array with vertically adjacent projection elements in form of spherical lenticules. The form deviations show that the course of the pitch lines of the lenticules is not constantly optically flat over the entire vertical course, and several lenticular-arrays are deformed to be curved. Here, at different horizontal section planes of the raster, the irregular course of the geometry of a lenticular-array is shown by Δr(1) (topmost horizontal pixel line), Δr(i) (a middle pixel line), and Δr(n) (lowest pixel line). Due to the fine structure of the lenticular-array, the pitch deviations within a lenticule can often be neglected.

In a schematic representation, FIG. 3b shows a not axis-true alignment of the optical mask to the controllable optical matrix, the pitch however being correct. Here the optical mask (LM*) is geometrically true within the permissible tolerances, but with its lenticules (L1*, L2*, . . . ) is rotated against the controllable optical matrix (BM). The axis deviation is illustrated by the angle of rotation α.

The information of the geometry of the irregular lenticule, in the simplest case, contains the parameter of a reference point (for example, the coordinates of the left upper corner point of the lenticular-array, further the centre of rotation (not shown in the figure), and the angle of rotation α. With these parameters, the choice of the pixels or subpixels for generating the sweet spots is initialized and derivable.

FIG. 4 shows the sweet spot unit as example of embodiment in an autostereoscopic display.

Such an exemplary display comprises, in the direction of light propagation, an illumination matrix, a projection matrix, and a following transmissive information display.

The shutter (2), here the controllable optical matrix (BM), consists of a matrix with a multitude of controllable openings (21, . . . ,) which are permeated by a backlight (1).

The subsequent optical mask (LM) consists of a lenticular-array with several adjacent lenticules (L1, L2, . . . ,) which here each are aligned parallel to the slits of the openings of the shutter. Following the lenticular-array, there is a transmissive information panel (5).

The optical mask (LM) focuses the light of the openings of the shutter such that the information panel (5) and a selectable preferred region of visibility (6) in the viewer plane (9) are illuminated in a directed manner.

Seen in horizontal direction of section, a certain number of openings of the shutter are assigned to the lenticular-array. This number is defined and given based on the geometry of the raster structure of the lenticular-array, here the pitch of the lenticules.

The controllable openings generate directed bundles of white light, one bundle of light being generated by only few neighbouring freed openings per lenticule so that typically only few openings are actively used at the same time. In the borderline case, only one opening is freed. The range of the openings that are assigned to a lenticule corresponds schematically with the range of the pixels of the image matrix from FIGS. 1 and 2, inclusive of the description.

The light from the large-area mask on its path to the sweet spots permeates the information panel, which time-sequentially modulates the light with the left or right image.

The matrix-like arranged openings of the illumination matrix are projected by a sub-sequent mask to sweet spots at predetermined regions, i.e. the right or left eyes of viewers, these positions detected by a position finder. A number of openings are exactly assigned to the spatial position of each projection element of the mask. Following the raster structure, that is the pitch of the lenticules, those openings are activated for each lenticular-array that project each sweet spot on to its predetermined region. As reference raster of the geometry of the lenticules the vertices or the border lines may be provided.

The display is provided with programming means so that the correct openings for sweet spot projection with the irregular lenticules can be chosen. Based on the information listed above, the pixel indices are assigned with help of programming means for recoding in order to select them, as has been described above, according to the irregular structure of the optical mask.

1. Sweet spot unit, containing a controllable optical matrix (BM), which comprises a multitude of controllable pixels which are regularly arranged, and an optical mask (LM*), which is tolerance-loaded due to manufacture or other influences, with projection elements (L1*, L2*, . . . ), whereby along a section along any line pixels of this line are assigned to the projection elements (L1*, L2*, . . . ), said pixels being projected to any predetermined sweet spots by projection elements, characterized by that those pixels assigned to the projection elements are activated by program means that are congruently projected into the predetermined sweet spots.

2. Sweet spot unit to claim 1, where the controllable optical matrix (BM) has a regular two-dimensional arrangement of pixels in rectangular, hexagonal, or other regular form.

3. Sweet spot unit to claim 1, where sections are made through any number of or all lines of the controllable optical matrix (BM) and those assigned pixels are activated for the projection elements cut that are optimally projected into the predetermined sweet spots.

4. Sweet spot unit to claim 1, where the direction, the regions and the number of the sweet spots are determined by position finders, which detect the position of the eyes of one or several viewers.

5. Sweet spot unit to claim 1, with a subsequent information panel is disposed, which modulates light and presents it sequentially and synchronously by positioning the sweet spots to right or left viewer eyes.

6. Sweet spot unit to claim 1, where in the borderline region of the assignment of pixels to neighbouring projection elements (L1*, L2*) the intensities of the pixels are overlapped.

7. Sweet spot unit to claim 6, where the intensity values for binary pixels, which can only be controlled by switching off or on, approximate the intensity intermediate values by time-sequential periodic switching operations.

8. Sweet spot unit to claim 1, where the optical mask (LM) is arranged distanced to the controllable optical matrix (BM).

9. Sweet spot unit to claim 1, where the optical mask (LM) and the controllable optical matrix (BM) are connected fixed to each other.

10. Sweet spot unit to claim 1, where the optical mask (LM) is a lenticular-array.

11. Sweet spot unit to claim 1, where the optical mask (LM) is a lenticular-array on a carrier film.

12. Sweet spot unit to claim 1, where the assignment of the pixels of the optical mask (LM) with regard to the controllable optical matrix (B) is changed during operation.

13. Sweet spot unit to claim 1, comprising means for storing information on the tolerances of the optical mask (LM*).

14. Sweet spot unit to claim 1, where each pixel consists of subpixels.

15. Sweet spot unit to claim 1, comprising a device for the determination and tracking of the position of the eyes of at least one viewer.
